(19) United States
(12) Patent Application Publication
(10) Pub. No.: US 2005/0205564 A1
(43) Pub. Date: Sep. 22, 2005

(54) Broiling oven

(75) Inventor: Christian Stahli, Glarus (CH)

Correspondence Address: PEARNE & GORDON LLP, 1801 EAST 9TH STREET, SUITE 1200, CLEVELAND, OH, 44114-3108, US

(73) Assignee: Electrolux Schwanden AG, Schwanden (CH)

(21) Appl. No.: 11/002,584

(22) Filed: Dec. 2, 2004

(30) Foreign Application Priority Data
Jan. 23, 2004 (DE) 10 2004 003 406.0

(51) Int. Cl. H05B 6/64

(52) U.S. Cl. 219/682

(57) ABSTRACT

This invention relates to a broiling oven encompassing
a) at least one cooking chamber (1), b) at least one microwave operating mode for cooking foods by means of microwaves and at least one thermal operating mode for cooking food by means of thermal radiation, with both cooking modes being selectable in alternative fashion or jointly, and
c) at least one door (2) for closing off at least one access opening of the cooking chamber, said door featuring
c1) at least one microwave shielding device (4) for preventing or reducing microwave leakage from the cooking chamber (1) when the door (2) is closed, and
c2) a microwave-permeable shield (6) that is heat-resistant especially to the temperatures generated in the thermal operating mode, that essentially consists of glass or a glass-ceramic material and that covers the microwave shielding device (4), with the door (2) closed, on an inside surface of the door which in the closed state of the door (2) faces at least in part the cooking chamber (1), relative to said cooking chamber (1).

This invention relates to a broiling oven.

Broiling ovens and cooking devices employing both microwave and resistance-heating technology are installed in increasing numbers especially in residential kitchens. Appliances of that type combine the advantages of a conventional cooking unit featuring resistance heating elements with those of a microwave oven. Microwave operation permits fast baking, broiling or roasting while the simultaneous operation of the resistance heating element ensures crispness and crunchiness of the food.

In view of the well-known dangers posed by microwave radiation for the human organism, makers of microwave ovens, or ovens with integrated microwave technology, must take all necessary steps to effectively shield the area around the microwave oven, or cooking device with integrated microwave capability, against the microwave radiation generated in the oven concerned.

As an established method to that effect, the viewing window in the oven door has been provided with metal screens or perforated metal sheets with a mesh or hole diameter that is significantly smaller than the wavelength of the microwaves employed in these ovens, thus effectively preventing the radiation from penetrating through the door.

However, microwaves can leak out of the oven through the gap that remains between the closed door and the frame around the access opening of the unit. To effectively seal the oven in that area against microwave leakage, microwave shielding devices have been used, such as impedance traps or a so-called λ/4 pocket. Microwave shields of that type may be mounted on the door of the oven in a way where they protrude into the cooking chamber, or they may be integrated into the door of the unit, thus retaining a flat surface on the inside of the door.

An impedance trap permits the creation of high impedance through appropriate geometric dimensions in the area of the critical gap, adapted to the wavelengths of the microwaves used, thus inhibiting microwave leakage through the gap. Details thereof are described for instance in U.S. Pat. No. 4,523,069.

λ/4 pockets have been described for instance in U.S. Pat. No. 3,182,164 and DE 33 28 748 A1. They consists of a cavity with an electrically conductive and, specifically, metallic surface with an aperture through which the microwaves can enter into the cavity. One of the inner dimensions of the cavity corresponds to about a quarter-wave of the microwaves employed. That eliminates or at least considerably weakens the microwaves. The λ/4 pockets thus serve as a trap for the microwaves. Therefore, these λ/4 pockets are also referred to as high frequency traps.

U.S. Pat. No. 4,584,447 in turn describes an improved design of the λ/4 pockets to the effect that the cavity is filled with a (nonconductive) dielectric, thus reducing the wavelength of the microwaves within the cavity. As a result, smaller cavity dimensions are possible.

In U.S. Pat. No. 3,182,164, DE 33 28 748 A1 and U.S. Pat. No. 4,584,447, the λ/4 pocket is positioned in the gap area between the closed door and the surrounding frame of the access opening of the oven and is installed either in or on the door, inhibiting microwave leakage through the gap.

The prior art cited above does not include a cover for the microwave shielding devices. DE 40 31 893 A1, however, does describe a pure microwave oven in which elements that constitute a trap for microwaves are positioned on an inner section of the door frame, which elements are covered by a molded component consisting of an insulating material such as silicone.

It is the objective of this invention to introduce an oven of the type referred to above, incorporating an advantageous shield for a microwave shielding device which shield in particular is thermally stable at the temperatures generated during thermal heating operation.

The invention achieves this objective with an oven having the characteristic features specified in patent claim 1. The subclaims to claim 1 cover advantageous configurational variations and enhancements.

As specified in claim 1, the invention is based on a design concept whereby an oven includes
a) at least one cooking chamber,
b) at least one microwave operating mode for cooking foods by means of microwaves and at least one thermal operating mode for cooking food by means of thermal radiation, with both cooking modes being selectable in alternative fashion or jointly, and
c) at least one door for closing off at least one access opening of the cooking chamber, said door featuring
c1) at least one microwave shielding device for preventing or reducing microwave leakage from the cooking chamber when the door is closed, and
c2) a microwave-permeable shield that is heat-resistant especially to the temperatures generated in the thermal operating mode, that essentially consists of glass or a glass-ceramic material and that covers the microwave shielding device, with the door closed, on an inside surface of the door which in the closed state of the door faces at least in part the cooking chamber, relative to said cooking chamber.

A cover of that type as employed for the microwave shielding device can be used without any problem at such temperatures as are typically generated in thermal operation such as resistance heating, without exposing the shield to any significant alteration, damage or similar effects.

In one form of implementation of the invention, the microwave shielding device encompasses one or several impedance trap(s). The concept of impedance traps has already been explained in the introductory description.

As an alternative or in addition, one preferred form of implementation provides for the microwave shielding device to include at least one λ/4 pocket. The concept of λ/4 pockets as well has been explained in the introductory description. In particular, λ/4 pockets can include a cavity in the door which on the inside of the door features an aperture for microwaves to pass through and at least one dimension of which essentially corresponds to a quarter-wave of the wavelength λ of the microwaves used for cooking in the microwave operating mode.

In one advantageous form of implementation the shield encompasses at least one pane (or panel).

According to one advantageous design version of the invention the microwave shielding device is positioned in the peripheral area on the inside of the door and in particular around a viewing window that is integrated into the door.

As another possible feature, the microwave shielding device is at least in part positioned opposite a frame that surrounds an access opening of the oven with the door closed.

In a preferred configuration of the invention, the microwave shielding device is integrated into the door in a manner whereby no part of the inside of the door protrudes into the cooking chamber.

Alternatively, however, the microwave shielding device may be mounted on the door in such fashion that it—and, preferably, its cover along with it—at least in part protrudes from the inside of the door into the cooking chamber.

In a practical design version of the oven according to the invention, the cover of the microwave shielding device extends at least in part into a space between a frame that surrounds the access opening of the oven and the closed door.

In a preferred design variation, the inside of the door is provided around its outer perimeter with a door frame that forms an essentially flush, flat surface with a side of the shield that at least in part faces the cooking chamber when the door is closed.

The shield preferably extends over essentially the area of the inside of the door that is surrounded by the door frame. It is particularly desirable, however, for the shield to extend over the inside of the door as a whole, thus also completely covering the access opening, and/or to constitute a contiguous inner surface or the inside of the door itself.

In a desirable form of implementation of the invention the oven is provided with a gasket which, when the door is closed, seals the cooking chamber against the escape to the outside of hot air and/or vapors, steam and/or odors generated in the cooking process. That gasket may be attached to a frame surrounding the access opening of the cooking chamber, although the gasket is preferably positioned on the inside of the door. Preferably, at least when the door is closed, the gasket is in close contact with the shield.

In an advantageous design enhancement of the oven according to the invention, a recess or groove is provided between the shield and the door frame for accepting the gasket.

The shield is preferably connected to the door, and specifically to an inner section of the door, by means of an adhesive. This provides not only a low-cost means for attaching the shield to the inside of the door but also a secure bond that withstands in particular the temperatures to which the shield is exposed without compromising its effectiveness. The adhesive used for bonding the glass to the door or inside section of the door is preferably applied in a jointing groove, assuring the desired distribution of the adhesive and the desired spread of the adhesive along the shield such as a glass plate.

In another preferred form of implementation the shield is opaque (impermeable to light waves, optically nontransparent) and especially printed over in the area in which it covers the microwave shielding device so as to obscure the microwave shielding device from the user of the oven. Doors made that way have a particularly elegant appearance.

The shield preferably also extends over a viewing window that is integrated into the door to permit looking into the cooking chamber when the door is closed. In the area in which it extends across the viewing window, the shield will desirably be transparent and not printed over, thus permitting visual inspection of the cooking chamber and a simple check on the broiling or baking status of the food.

In a desirable design version of the oven according to the invention, the inside of the oven door is flush with the cooking chamber of the oven so as not to protrude into the latter.

In this fashion and by virtue of the above-described configurations according to the invention, it is possible to obtain a flat inside door surface without any projecting corners, which makes for easy cleaning of the door. Apart from facilitated cleaning and an elegant appearance, this door design reduces the possibility of an injury, compared especially to doors with attached λ/4 pockets with many open corners and edges. As far as appearance is concerned, it should be mentioned that, at first glance, the door looks like that of a conventional, thermally heated oven without a microwave capability.

In a desirable form of implementation of the oven according to the invention, the door is attached to the oven in tiltable fashion via at least one hinge.

In another design version, the oven door may be a component of a retractable carriage-type baking rack, nowadays found in many broiling and baking-oven designs. Such retractable baking racks facilitate access to the food being cooked, broiled or baked as well as its removal from the oven unit.

The following description will explain this invention in more detail, including additional features and advantages, on the basis of design examples and with reference to the attached drawings in which

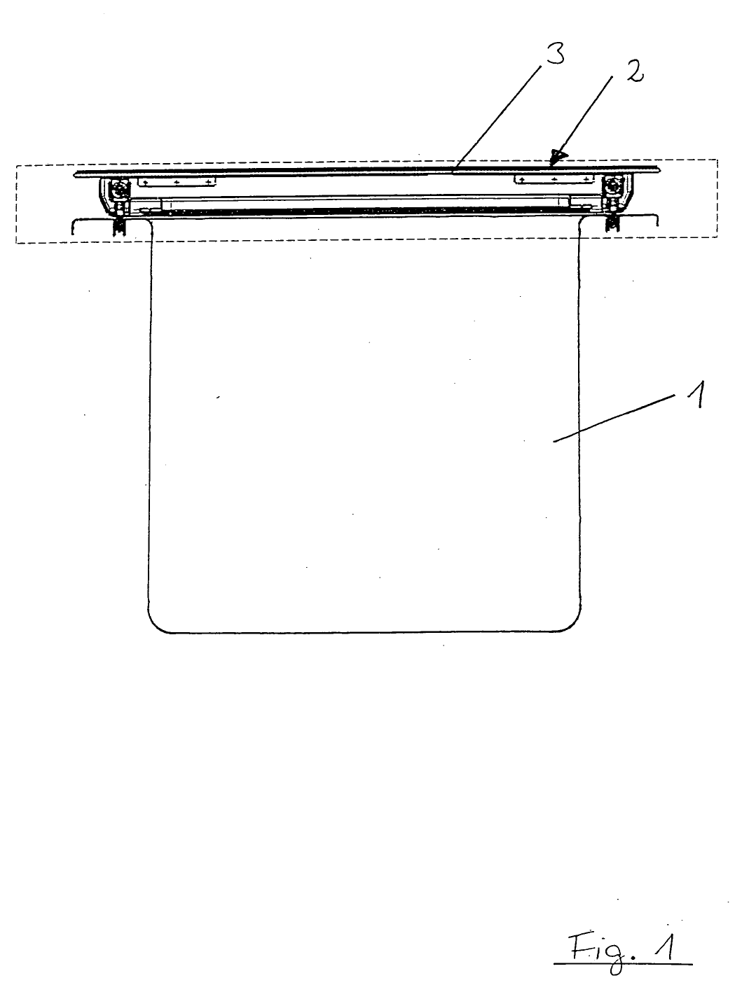

FIG. 1 is a cross-sectional top view of the door and cooking chamber of a broiling oven according to the invention;

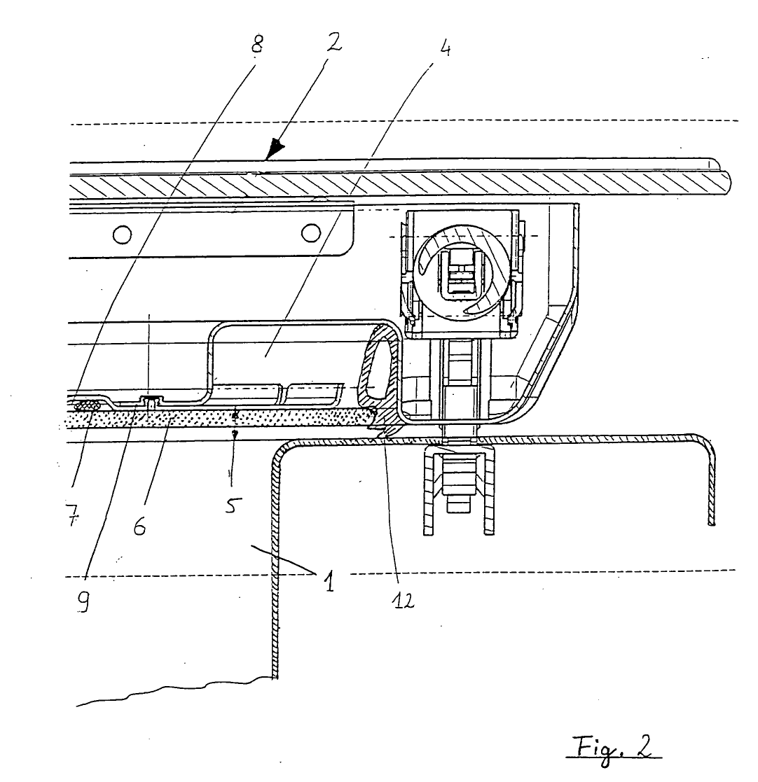

FIG. 2 is a detail drawing of a corner section thereof; and

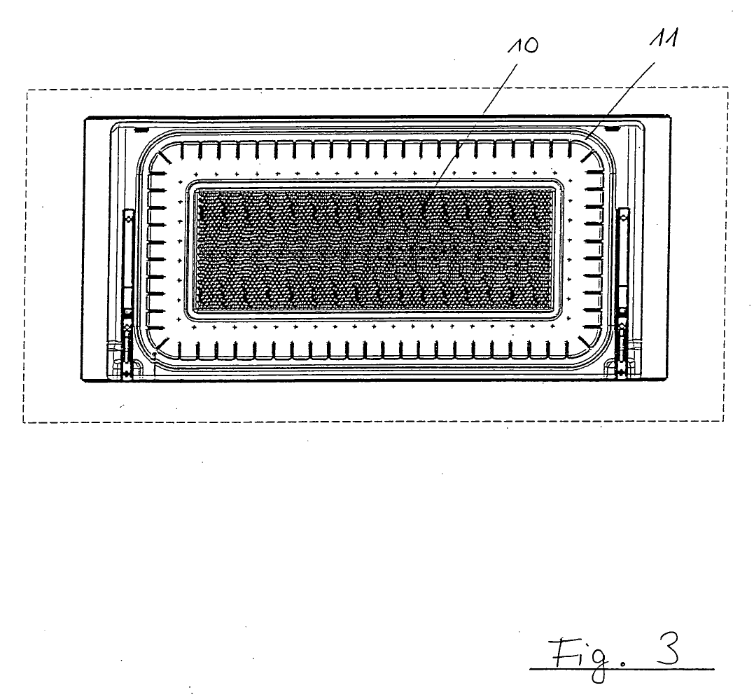

FIG. 3 is a front view of the inside of the door of a broiling oven according to the invention.

FIG. 1 is a cross-sectional top-view illustration of parts of an oven with both microwave and thermal heating capability. It shows a cooking chamber 1 that may also be referred to as a baking compartment, closed off by a door 2. In the cooking chamber of this oven, food can be heated by means of resistance heating elements and/or by microwaves. The cooking chamber 1 is closed off by a door 2 that is shielded from its surroundings by an outer glass panel 3. Using for the shield an outer glass panel 3 constituting a viewing window 10 (see FIG. 3) permits the visual inspection of the food being broiled or baked in the cooking chamber.

FIG. 2 shows in detail a section of the illustration in FIG. 1. Specifically, it depicts a corner of the structure per FIG. 1. To prevent microwaves from leaking past the door area, the door 2 is provided with an integrated λ/4 pocket serving as a microwave shielding device. To permit flush shielding of the λ/4 pocket 4 so as to avoid protruding corners and edges, the distance 5 between a frame around the access opening of the cooking chamber 1 and the λ/4 pocket 4 is so chosen that a glass panel 6 (shield, glass pane) can be inserted in a flush arrangement.

The glass panel 6 is microwave-permeable and thermally stable i.e. heat-resistant. In the area in which it covers the λ/4 pocket, the glass panel 6 is printed over in a way as to hide the λ/4 pocket 4 from the user's view, thus creating an attractive appearance of the door and the oven itself. By means of a suitable adhesive 7, applied in a jointing groove 8, the glass panel 6 is bonded to the interior section 9 of the door. Also integrated into that interior door section 9 is a viewing window 10.

FIG. 3 is a front view of the inside of the oven door 2. The aforementioned viewing window 10 is rectangular and centered in the door 2. To prevent microwaves from penetrating through the outer glass panel 3, the viewing window 10 is provided with a perforated metal plate or foil, facing the inside of the oven. The perforations are such as to permit easy viewing of the cooking chamber 1. The cooking chamber 1, itself shielded by the glass panel 6 on the inside of the door 2, can be viewed because the area of the glass panel 6 that serves as the viewing window 10 is not printed over. A gasket 12 (see detail in FIG. 2), embedded in a groove 11 between the interior door section 9 and the glass panel 6, serves to seal the cooking chamber so as to minimize the escape of baking and cooking vapors to the outside as well as heat loss.

The above describes the configuration of a flat inside of the door 2 without any projecting corners that would complicate the cleaning of the door. The only interruption of the level surface is a thin gasket 12 composed of silicone. Besides silicone, there are many other suitable sealing compounds with which those skilled in the art are familiar.

At this juncture it is pointed out again that the door 2 is designed for both microwave operation and operation with conventional heating elements as well as for the combined simultaneous use of both modes for heating foods. The flat door also reduces the danger of an injury posed by exposed corners and edges. The design ensures the shielding of the oven from the penetration of microwaves to the outside area while an integrated silicone gasket 12 seals the oven against the escape of vapors from the cooking chamber. No separate shielding of the λ/4 pocket 4, indispensable in the case of attached λ/4 pockets, is necessary.

The design of the invention is not limited to the example described above but can be configured in numerous variations within the scope of professional applications.

### LIST OF REFERENCE NUMBERS

1 Cooking chamber, baking compartment

2 Door

3 Outer glass panel

4 Microwave shielding device, λ/4 pocket

5 Distance between the frame of the access opening and the λ/4 pocket, gap dimension

6 Shield, glass panel, glass pane

7 Adhesive

8 Jointing groove

9 Interior door section

10 Viewing window

11 Groove

12 Gasket

1. Broiling oven encompassing
a) at least one cooking chamber (1),
b) at least one microwave operating mode for cooking foods by means of microwaves and at least one thermal operating mode for cooking food by means of thermal radiation, with both cooking modes being selectable in alternative fashion or jointly, and
c) at least one door (2) for closing off at least one access opening of the cooking chamber, said door featuring
c1) at least one microwave shielding device (4) for preventing or reducing microwave leakage from the cooking chamber (1) when the door (2) is closed, and
c2) a microwave-permeable shield (6) that is heat-resistant especially to the temperatures generated in the thermal operating mode, that essentially consists of glass or a glass-ceramic material and that covers the microwave shielding device (4), with the door (2) closed, on an inside surface of the door which in the closed state of the door faces at least in part the cooking chamber (1), relative to said cooking chamber (1).

2. Oven as in claim 1, in which the microwave shielding device includes at least one impedance trap.

3. Oven as in claim 1, in which the microwave shielding device includes at least one ¼ pocket (4).

4. Oven as in claim 3, in which the ¼ pocket (4) encompasses a cavity in the door (2) which features on the inside of the door a microwave-permeable aperture and of which at least one dimension essentially corresponds to one fourth of the wavelength 1 of the microwaves employed in the microwave operating mode.

5. Oven as in claim 1, in which the shield (6) includes at least one glass panel.

6. Oven as in claim 1, in which the microwave shielding device (4) is positioned at least in the peripheral area of the inside of the door (2) and in particular around a viewing window (10) that is integrated into the door (2).

7. Oven as in claim 1, in which, when the door (2) is closed, the microwave shielding device (4) is at least in part positioned opposite a frame surrounding the access opening of the oven.

8. Oven as in claim 1, in which the microwave shielding device (4) is integrated into the door (2) in such fashion that the inside of the door is free of any projections that would protrude into the cooking chamber (1).

9. Oven as in claim 1, in which the microwave shielding device (4) is mounted on the door (2) in such fashion that it extends at least partly from the inside of the door (2) into the cooking chamber (1).

10. Oven as in claim 1, in which the shield (6) extends at least partly into a space (5) which, when the door (2) is closed), exists between a frame that surrounds the access opening of the oven and the door (2).

11. Oven as in claim 1, in which the inside of the door is provided with a door frame around its perimeter that forms an essentially level, flush surface with a side of the shield (6) at least part of which faces the cooking chamber (1) when the door (2) is closed.

12. Oven as in claim 11, in which the shield (6) essentially extends over the entire area of the inside of the door that is surrounded by the door frame and/or constitutes a contiguous inner surface of, or the inside itself, of the door.

13. Oven as in claim 1, in which a gasket (12) is provided which, when the door is closed, seals the cooking chamber (1) so as to prevent hot air and/or cooking vapors, steam and/or odor from escaping to the outside.

14. Oven as in claim 13, in which the gasket (12) is positioned on a frame that surrounds the access opening of the cooking chamber (1).

15. Oven as in claim 13, in which the gasket (12) is positioned on the inside of the door and/or is in close contact with the shield at least when the door is closed.

16. Oven as in claim 15, with a gap or groove between the shield (6) and the door frame in which the gasket (12) is inserted.

17. Oven as in claim 1, in which the shield (6) is bonded, by means of an adhesive (7), to the door (2) and in particular to an interior door section (9).

18. Oven as in claim 10, in which the inside of the door is provided with a jointing groove (8) that holds or permits the insertion of the adhesive (7) for the purpose of bonding the shield (6) to the door (2) or to the interior door section (9).

19. Oven as in claim 1, in which the area of the shield (6) that covers the microwave shielding device (4) is opaque and especially printed over.

20. Oven as in claim 1, in which the shield (6) also covers a viewing window (10) integrated into the door (2) that permits visual inspection of the cooking chamber when the access opening of the cooking chamber is closed.

21. Oven as in claim 20, in which the area of the shield (6) that covers the viewing window (10) is transparent and specifically not printed over.

22. Oven as in claim 1, in which the inside of the door (2) is flush with the cooking chamber (1) of the oven in a way as not to protrude into the latter.

23. Oven as in claim 1, with a door (2) that is attached to the oven in tiltable fashion via at least one hinge.

24. Oven as in claim 1, with a door (2) that is a component of a retractable baking rack.
